(19) United States
(12) Patent Application Publication
(10) Pub. No.: US 2012/0256076 A1
(43) Pub. Date: Oct. 11, 2012

(54) COMPOSITE STRUCTURE TOOL

(76) Inventors: Tommy Grankall, Borensberg (SE); Anders Lundberg, Vikingstad (SE); Jan Andersson, Linkoping (SE); Mikael Petersson, Linkoping (SE); Björn Weidmann, Borensberg (SE); Jan Waara, Linkoping (SE); Per Hallander, Linkoping (SE)

(21) Appl. No.: 13/510,366

(22) PCT Filed: Nov. 17, 2009
(86) PCT No.: PCT/SE09/51301

§ 371 Date: Jun. 21, 2012

(51) Int. Cl. B29C 33/40; B29C 70/54

(52) U.S. Cl. 249/117; 156/182

(57) ABSTRACT

A method of producing a forming tool and a forming tool for forming an article. The forming tool includes a composite face sheet having a forming surface and an inner surface opposite the forming surface. A support structure is attached to the inner surface of the composite face sheet. The support structure includes a support shell of composite having a first surface facing the inner surface of the composite face sheet and having a second surface opposite the first surface. The support structure further includes distance members. The support shell is fixed at a distance from the composite face sheet by the distance members.

### TECHNICAL FIELD

The present invention relates to a forming tool according to the preamble of claim 1 and a method of producing a forming tool according to claim 6.

### BACKGROUND ART

Forming large-scale articles of composite requires a forming surface of the forming tool which is large and stiff. One way to provide a forming surface of a so called composite face sheet is to produce the latter in a mould by means of resin injection into a fibre reinforcement structure and by vacuum being introduced under a vacuum bag. However, such composite face sheet, having a forming surface for forming the article, must be stiffened for maintaining the shape during the forming and curing procedure of the article. Today the forming tool's support part consists of a frame of beams and ribs onto which the composite face sheet is fixed.

U.S. Pat. No. 5,433,418 discloses a forming tool having a forming shell to be locked into place and connected to a support frame for stiffening the forming shell (or composite face sheet) with a complex shape. The forming shell is allowed to flex for facilitating the removal of the cured composite article from the forming shell.

However, it is still desired that a composite structure tool is available, that is easy to handle and which provides for a fast production of articles. It is at the same time desired that the composite structure tool is of low weight and time-saving to build.

### SUMMARY OF THE INVENTION

This has been achieved by the forming tool defined in the introduction being characterized by the features of the characterizing part of claim 1.

Thereby a forming tool is achieved which is cost-effective and time saving to produce. The forming tool is by its face to face assembled sheet and shell features extremely rigid and will thus provide for a small tolerance discrepancy. The empty space (only filled with e.g. hollow distance members disposed at suitable positions) between the composite face sheet and support shell will provide for a free path for heating or cooling air passing the inner surface of the composite face sheet thus promoting for a very fast curing cycle for the article to be produced, such as a large-scale article of composite.

Alternatively, the respective distance member has a first end attached to the inner surface of the composite face sheet and a second end attached to an edge area of a corresponding through hole in the support shell.

In such way the assembly of the forming tool can be achieved in a very short time. By making the through holes in the support shell at places corresponding with the estimated placement of the respective distance member, each distance member can be inserted through the respective through hole until the first end reaches the inner surface of the composite face sheet and the second end rests against the peripheral surface of the through hole. The composite face sheet and the support shell are already held fixed to each other with a holding device. Thereafter the distance members are fastened at essentially the same time by means of adhesive to the composite face sheet and the support shell, and when the adhesive is cured the holding device will be removed. By the through holes is thus achieved a simplified assembly of the forming tool.

Suitably, the distance members are formed of hollow circular composite tubes.

In this manner the distance members will provide for a possibility for heating or cooling air to reach the inner surface of the composite face sheet via the interior of the tubular distance members. Suitably, each tubular distance member has through holes through its sides to achieve an effective air passage to the interior of the distance member. The total weight of the forming tool will thereby also reduced, which promotes for an easy handling of the forming tool in the production line.

Preferably, the support shell is arranged parallel with the composite face sheet.

Thereby is achieved that a master tool, —comprising a primary surface for forming the composite face sheet having a contour corresponding with a composite article to be formed—, can be used also for forming the support shell. This promotes for a cost-effective production of the forming tool.

Alternatively, support legs are attached to the second surface of the support shell for supporting the forming tool when placed on a floor.

In such way the forming tool will be easy to handle in a production line. No extra heavy and rigid feet assembly has to be mounted under the forming tool. The forming tool per se will work as a rigid platform just requiring a support onto the floor via the support legs. Preferably, the number of support legs is three. Thereby is achieved an optimal number which is of low weight and which do not require an even floor or an exact adjustment of the length of the support legs.

Alternatively, the support shell is thinner than the composite face sheet and is made of composite comprising structural fibres. Thus the weight is reduced still achieving a rigid tool.

This has also been achieved by the method defined in the introduction being characterized by the steps of claim 6.

Thereby a method is provided for producing a forming tool which is rigid and which is of low weight and which promotes for a short curing cycle. The method itself promotes for a cost-effective assembly of the forming tool, since the forming tool is uncomplicated to assemble and it comprises relatively few parts. It is thus cost-effective and time saving to produce. By holding the support shell at a distance from the composite face sheet, such that the inner surface of the latter is facing the first surface (inner surface) of the support shell, distance members can be fastened to the inner surface and the first surface, wherein the forming tool can be produced in one assembling step. Preferably the support shell is a plane shell and being reused for different composite face sheets having different contours. Alternatively the support shell curvature is identical with the composite face sheet. Thereby is achieved that the support shell can be made in the same master tool also made for forming the composite face sheet.

Preferably, the method also comprises a step of providing through holes through the support shell for fastening the respective distance member to the support shell via an edge area of the corresponding through hole.

In such way the assembly of the forming tool can be achieved in a very short time. By making the through holes in the support shell at places corresponding with the estimated placement of the respective distance member, each distance member can be inserted through the respective through hole (wherein the composite face sheet is held at a distance from the support shell by the removable holding device) until the first end reaches the inner surface of the composite face sheet and the second end rests against the peripheral surface of the through hole. The distance members are bonded by means of adhesives—in one working routine—to the composite face sheet and the support shell. The composite face sheet and the support shell are thus held fixed at a distance from each other by the holding device, which later on will be removed. By the through holes is thus achieved a simplified method for assembling the forming tool.

Alternatively, the method also comprises a step of holding the composite face sheet on the primary surface during the fastening of the distance members.

In such way the contour of the forming surface of the composite face sheet will be held in an exact shape corresponding with the contour of the master tool's primary surface, —which in turn corresponds with the contour of the article to be produced—, wherein the support shell is held at a distance from the composite face sheet by the holding device, and the distance members are in one working routine fastened to the composite face sheet and to the support shell. When the fastening of the distance members is made, the finished forming tool is removed from the master tool.

Suitably, the method also comprises a step of forming and curing the support shell on the primary surface.

A support shell is thus made which can be formed and cured in the same master tool as the composite face sheet. This provides for a cost-effective manufacture of the forming tool.

Preferably, the article to be formed is a large-scale shell article for an aircraft. Thereby an aircraft can be produced more cost-effective since the production of the forming tool is simplified and the curing cycle is shortened compared with prior art. Due to the double shell tool features a rigid tool is provided having capability to provide small tolerances in contour shape discrepancy.

Preferably, the method also comprises a step of fastening support legs to a second surface of the support shell being opposite the first surface of the latter.

Thus the forming tool can be completed with legs when it still lies upside-down on the master tool, wherein the legs can be fastened to the second surface, i.e. to an underside of the finished forming tool. Thereafter the forming tool is turned onto its legs and is clear to use.

Preferably, the number of support legs mounted is three. Thereby is achieved an optimal number which is of low weight and which do not require an even floor or an exact adjustment of the length of the support legs.

Suitably, a third sheet is fastened to and a distance from the forming tool's underside for increasing the rigidity of the forming surface.

Preferably, the whole forming tool is made of composite. Alternatively, the composite is reinforced by fibre structures. Eventual thermal expansions due to different material properties are thus eliminated.

### BRIEF DESCRIPTION OF THE DRAWINGS

The present invention will now be described by way of examples with references to the accompanying schematic drawings, of which:

FIG. 1a illustrates a master tool comprising a primary surface for production of a composite face sheet and a support shell;

FIG. 1b illustrates distance members of a forming tool according to a first embodiment;

FIG. 1c illustrates mounting of three legs to the forming tool in FIG. 1b;

FIG. 2a illustrates components in a production of a forming tool according to a second embodiment;

FIG. 2b illustrates the holding of the support shell at a distance from the composite face sheet during production of the forming tool;

FIG. 2c illustrates a method step of holding the composite face sheet on the primary surface during the fastening of the distance members shown in FIG. 2a;

FIG. 2d illustrates the placement of the finished forming tool in FIG. 2c onto isolating supports;

FIG. 3 illustrates distance members arranged with even distribution and attached to the inner surface of the composite face sheet;

FIG. 4 illustrates, in an enlarged side view, a fastened distance member according to a third embodiment; and

FIG. 5 illustrates, in a plane view, the placement of distance members, one of which is shown in FIG. 4, onto the inner surface.

### DETAILED DESCRIPTION

Hereinafter, embodiments of the present invention will be described in detail with reference to the accompanying drawings, wherein for the sake of clarity and understanding of the invention some details of no importance are deleted from the drawings.

The definition of “male tool” could also include the meaning of “master tool block”, i.e. a tool for forming tool sheets and support sheets.

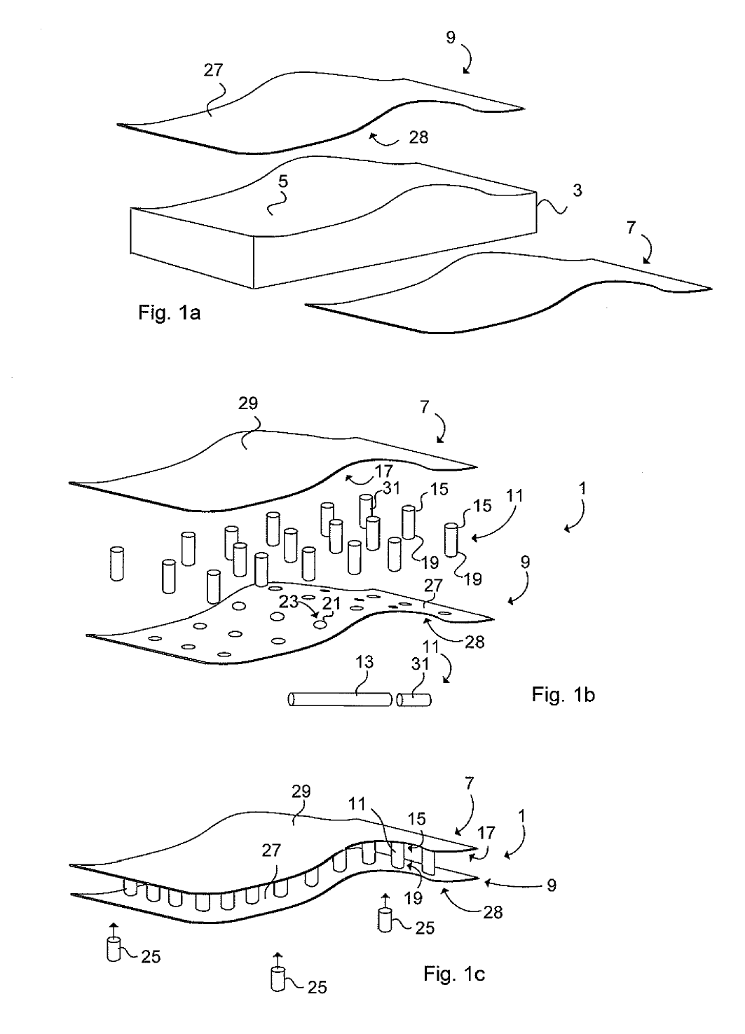

FIG. 1a schematically illustrates a master tool 3 comprising a primary surface 5 for production of a composite face sheet 7 and a support shell 9. The master tool 3 is made of wood. The primary surface 5 is provided with a release film (not shown) for providing that the composite face sheet 7 and the support shell 9 easy can be removed from the master tool 3 after their forming and curing steps. Firstly, the composite face sheet 7 is formed and cured by means of laying pre-preg plies (not shown) onto the primary surface 5, enclosing the lay-up (a blank) in a vacuum bag (not shown) and forming the lay-up by means of the produced under-pressure conforming the lay-up after the contour of the primary surface 5 and heating the lay-up by means of a heating source (not shown) to a curing temperature. When the lay-up, now constituting the composite face sheet 7, is cured, cooling of the latter is performed. Thereafter the same procedure is made with the production of the support shell 9. The composite face sheet 7 and the support shell 9 each have a contour shape being identical according to a first embodiment and are used for assembly of a forming tool 1, shown in FIG. 1c.

FIG. 1b schematically illustrates, in an exploded view, distance members 11 of the forming tool 1 comprising the composite face sheet 7 and the support sheet 9. The distance members 11 are cut from an elongated hollow circular tube 13 of reinforced composite into preferred lengths, each cut section constituting hollow circular composite tubes 31. Each hollow circular composite tube 31 has a first end 15 provided to be attached to an inner surface 17 of the composite face sheet 7. A second end 19 of the hollow circular composite tube 31 is provided to be attached to an edge area 21 of a corresponding through hole 23 in the support shell 9. The support shell 9 is prepared with the through holes 23 by milling of material from the support shell 9 prior holding the support shell 9 at a distance from the composite face sheet 7 and before the mounting of the hollow circular composite tubes 31.

FIG. 1c schematically illustrates mounting of three legs 25 (each being cut from the elongated hollow circular tube 13 in FIG. 1b as well) to the finished first embodiment forming tool 1 made of the components shown in FIG. 1b. The forming tool 1 per se will work as a rigid platform just requiring the three legs 25 as a support onto a floor (not shown). Thereby is thus achieved an optimal number of legs 25 which provides for a low weight of the forming tool and which does not require an even floor or an exact adjustment of the length of the support legs 25. The support legs 25 are attached by means of adhesives to a second surface 28 of the support shell 9 for supporting the forming tool 1 when placed on the floor. Thereby a forming tool 1 for forming an article (not shown), such a double curved shell, is achieved, which is cost-effective and time saving to produce and which still has a stiffness and is rigid. The forming tool 1 comprises the composite face sheet 7 having a forming surface 29 for forming the article (not shown) and the inner surface 17, which being the side opposite the forming surface 29. The forming tool 1 further comprises the support shell 9 being attached to the inner surface 17 of the composite face sheet 7 by means of the distance members 11. The support shell 9 is made of composite and has a first surface 27 facing the inner surface 17 of the composite face sheet 7 and has the second surface 28 (underside of the forming tool 1) opposite the first surface 27. The support shell 9 is fixed at a distance from the composite face sheet 7 by means of the distance members 11. The distance members 11 are thus formed as the hollow circular composite tubes 31. The hollow interior of the distance member 11 provides for an effective airflow needed for an effective curing. The total weight of the forming tool 1 will thereby also be reduced, which promotes for an easy handling of the forming tool 1 in the production line. The support shell 9 is arranged, in the forming tool 1, parallel with the composite face sheet 7.

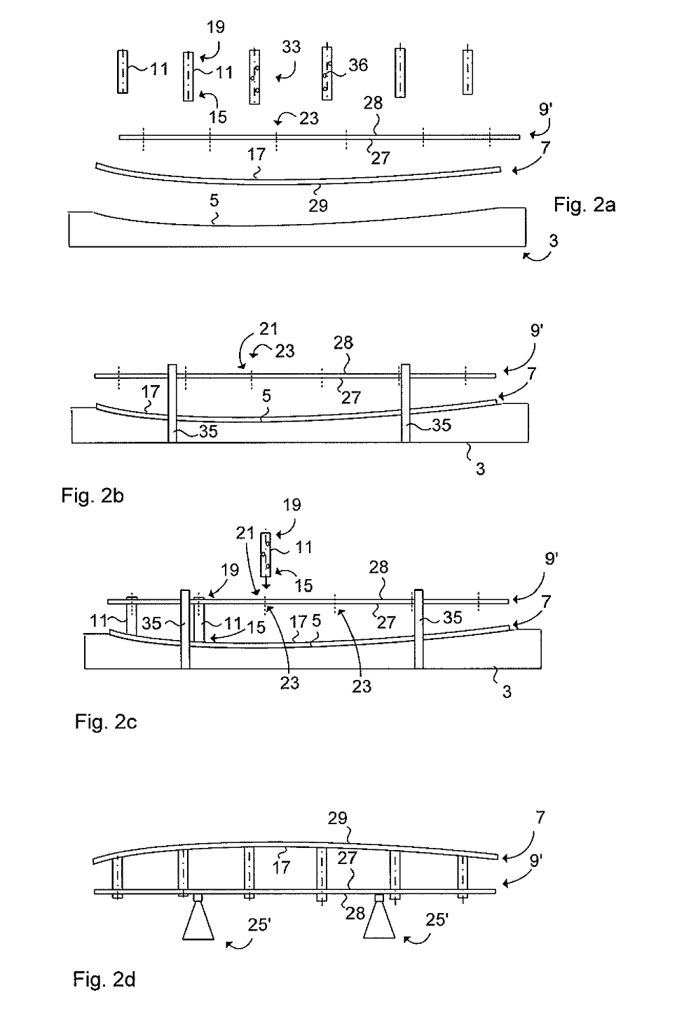

FIG. 2a schematically illustrates components in a production of a forming tool 1 according to a second embodiment. Distance members 11 having a cross-section formed quadratic are provided as tubes 33, which are hollow and which have suitable lengths. The tubes 33 have bores 36 extending through the tubes' 33 sidewalls to achieve an effective air passage to the interior of the tubes 33 and the inner surface 17. The total weight of the forming tool will thereby also reduced, which promotes for an easy handling of the forming tool in the production line and also gives a faster curing cycle. A plane support shell 9′ is provided being thinner than the composite face sheet 7 and is made of composite comprising structural fibres. Thus the weight is reduced still achieving a rigid tool. The support shell 9′ is provided with through holes 23 being placed after a certain pattern depending on the desired location of the distance members 11 for achieving a certain stiffness of the forming tool 1 to be assembled. The composite face sheet 7 is formed and cured in the master tool 3.

As being illustrated schematically in FIG. 2b, the holding of the support shell 9′ at distance from the composite face sheet 7 is achieved by arranging holding devices or pillars 35 to the master tool 3, which pillars 35 also are fastened releasable to the support shell 9′ by means of clamps (not shown). The composite face sheet 7 and the support shell 9′ are thus initially held fixed in position relatively to each other via the pillars 35. Thereafter the distance members 11 are bonded in one step to the composite face sheet 7 and the support shell 9′. When the adhesive has cured, the pillars 35 are removed. The composite face sheet 7 is held onto the primary surface 5 of the master tool 3 by means of vacuum produced by a vacuum source (not shown) during the fastening of the distance members 11 to the composite face sheet 7 and to the support shell 9′, as can be seen in FIG. 2c. Each distance member 11 is pushed through a corresponding through hole 23 until the distance member 11 reaches the inner surface 17 of the composite face sheet 7. Between the composite face sheet's 7 inner surface 17 (within the area of the end of the distance member) and the end of the distance member 11 is an adhesive applied, so that when all distance members 11 are in place, first ends 15 of the distance members 11 are bonded onto the inner surface 17 and second ends 19 are bonded to edge areas 21 of the corresponding through holes 23 in the support shell 9′. By the through holes 23 is thus achieved a simplified assembly of the forming tool 1. According to this embodiment no legs are fastened to the second surface 28 (underside of the forming tool 1) of the support shell 9′ when the forming tool 1 lies “upside-down”. Instead the forming tool 1 is turned to its working position onto isolated supports 25′ providing isolation against heat leakage during the curing cycle. See FIG. 2d schematically illustrating the now into working position turned finished forming tool 1 clear for use.

FIG. 3 illustrates the principle for distance members 11 being arranged with even distribution between each other onto the inner surface 17 of the composite face sheet 7. Points P of intersecting, where the centre lines CL of each distance member 11 and the composite face sheet 7 meet, have the same distance to each other according to the lengths L. The centre line CL is oriented perpendicular to the plane of the composite face 7 sheet surrounding the distance member 11 connected to the composite face sheet 7.

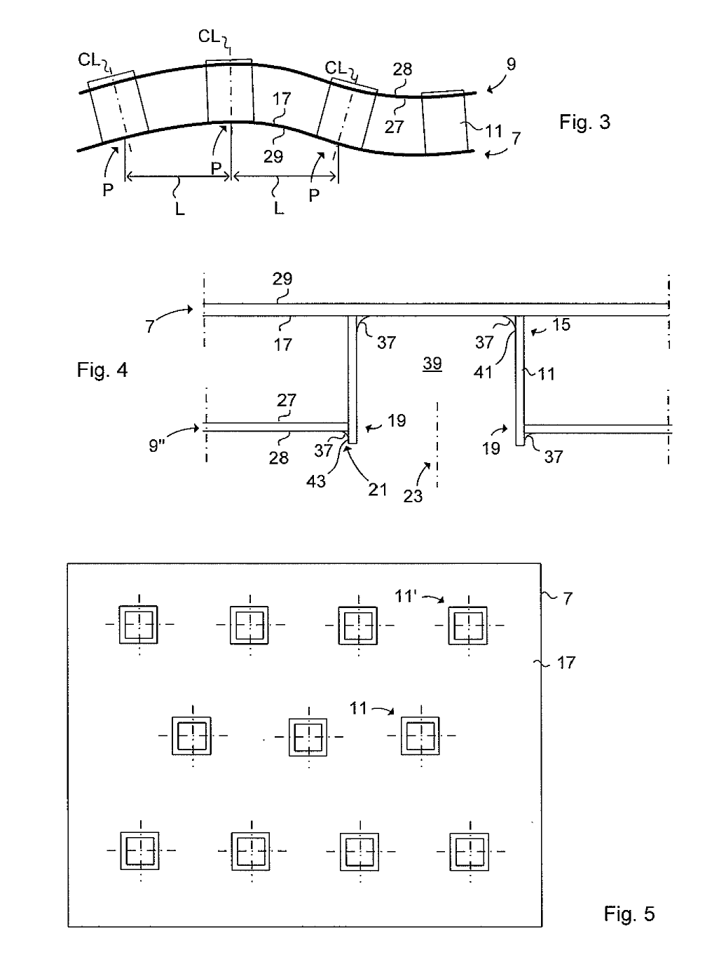

FIG. 4 illustrates the distance member 11 fixedly mounted to the composite face sheet 7 and the support shell 9″ according to a third embodiment. The distance member 11 is hollow. After that the distance member 11 has been pushed through the through hole 23 of the support shell 9″ and meets the inner surface 17 of the composite face shell 7, adhesive 37 is applied from inside the interior 39 of the hollow distance member 11 to the inner edge area 41 of the first end 15 of the distance member 11 (or onto the cut end edge of the distance member for avoiding a crimp of the adhesive 37) and the inner surface 17 of the composite face sheet 7 within the area of the interior 39. At the same time adhesive 37 is applied to the outer edge area 43 of the second end 19 of the distance member 11 and the second surface 28 of the support shell 9″ within the edge area 21 of the through hole 23. The composite face sheet 7 and the support shell 9″ are fixed at a distance from each other before the distance members 11 are bonded into position.

FIG. 5 illustrates schematically the placement of distance members 11, one of which is shown in FIG. 4, onto the inner surface 17 of the composite face sheet 7. The outer placed distance members 11′ are of larger number than the central distance members 11, still reaching a stiff forming tool 1. This promotes for a cost-effective production of the forming tool 1 since it is labour saving.

The present invention is of course not in any way restricted to the preferred embodiments described above, but many possibilities to modifications, or combinations of the described embodiments, thereof should be apparent to a person with ordinary skill in the art without departing from the basic idea of the invention as defined in the appended claims. The composite of the forming tool can be epoxy, polymides, bismaleimides, phenolics, cyanatester, PEEK, PPS, Polyester, Vinylester and other curable resins or mixtures thereof. If used, the fibre structure may be of ceramic, carbon and metal or mixtures thereof. Of course can a further support shell be attached to the forming tool for strengthening certain portions of the forming tool requiring strength against larger forming forces in that portions than other portions. Of course the fastening of the distance members to the composite face sheet and the support shell can be performed by other means than gluing. For example, welding, screwing, nailing, clamping, taping are some ways of fastening. Of course, the distance between the distance members' respective centre line meeting the plane of the composite face sheet is not restricted to be the same. The male tool may be made of wood, plastic, metal or of any other suitable material. The forming and curing of the article to be produced can be made without the additional use of vacuum and heat.

1. A forming tool for forming an article, the forming tool comprising:
a composite face sheet having a forming surface and an inner surface opposite the forming surface, and
a support structure being attached to the inner surface of the composite face sheet, wherein the support structure comprises a support shell of composite having a first surface facing the inner surface of the composite face sheet and having a second surface opposite the first surface, the support structure further comprises distance members, and wherein the support shell is fixed at a distance from the composite face sheet by the distance members.

2. The forming tool according to claim 1, wherein the respective distance member has a first end attached to the inner surface of the composite face sheet and a second end attached to an edge area of a corresponding through hole in the support shell.

3. The forming tool according to claim 1, wherein the distance members are formed of hollow circular composite tubes.

4. The forming tool according to claim 1, wherein the support shell is arranged parallel with the composite face sheet.

5. The forming tool according to claim 1, wherein support legs are attached to the second surface of the support shell for supporting the forming tool when placed on a floor.

6. A method of producing a forming tool, the method comprising:
providing a master tool comprising a primary surface having a contour corresponding with a composite article to be formed;
forming and curing a blank on the primary surface for producing a composite face sheet comprising a forming surface and an inner surface opposite the forming surface;
providing a support shell at a distance from the composite face sheet such that the inner surface of the latter is facing a first surface of the support shell; and
fastening distance members to the inner surface and to the support shell so that the support shell is fixed at a distance from the composite face sheet.

7. The method according to claim 6, further comprising:
providing through holes through the support shell for fastening the respective distance member to the support shell via an edge area of the corresponding through hole.

8. The method according to claim 6, further comprising:
holding the composite face sheet on the primary surface during the fastening of the distance members.

9. The method according to claim 6, further comprising:
forming and curing the support shell on the primary surface.

10. The method according to claim 6, further comprising:
fastening support legs to a second surface of the support shell being opposite the first surface of the support shell.
